(19) United States
(12) Patent Application Publication
(10) Pub. No.: US 2026/0159204 A1
(43) Pub. Date: Jun. 11, 2026

(54) SYSTEM FOR AND METHOD OF REMOTELY OPERATING WATERCRAFT

(71) Applicant: YAMAHA HATSUDOKI KABUSHIKI KAISHA, Iwata-shi (JP)

(72) Inventor: Hiroshi INOUE, Shizuoka (JP)

(21) Appl. No.: 19/188,348

(22) Filed: Apr. 24, 2025

(30) Foreign Application Priority Data
Apr. 25, 2024 (JP) 2024-071400

(51) Int. Cl. B63B 79/40; B63B 79/15; B63B 79/30; G05D 1/226; G05D 1/611; G05D 1/65; G05D 1/85; G05D 109/30

(52) U.S. Cl. CPC B63B 79/40; B63B 79/15; B63B 79/30; G05D 1/226; G05D 1/611; G05D 1/65; G05D 1/85; B63B 2203/00; G05D 2109/34

(57) ABSTRACT

A system for remotely operating a watercraft includes a controller, a communication interface, and a communication switch. The controller is disposed on the watercraft and is configured or programmed to control the watercraft, the communication interface is disposed on the watercraft and is configured to perform satellite communication using a satellite and terrestrial communication using a ground base station, and the communication switch is configured to switch a communication method of the communication interface between the satellite communication and the terrestrial communication. When radio waves transmitted from the ground base station are not receivable by the communication interface, the communication switch is configured to switch the communication method of the communication interface from the terrestrial communication to the satellite communication.

### CROSS REFERENCE TO RELATED APPLICATIONS

This application claims the benefit of priority to Japanese Patent Application No. 2024-071400 filed on Apr. 25, 2024. The entire contents of this application are hereby incorporated herein by reference.

### BACKGROUND OF THE INVENTION

### 1. Field of the Invention

The present invention relates to systems for and methods of remotely operating watercraft.

### 2. Description of the Related Art

Japan Laid-open Patent Application Publication No. 2020-132095 discloses a technology regarding remotely operating a watercraft.

When satellite communication is used as the communication means for remotely operating a watercraft, for instance, communication is enabled even in the open ocean. However, satellite communication is more delayed than terrestrial communication. On the contrary, when terrestrial communication is used as the communication means for remotely operating a watercraft, terrestrial communication is less delayed than the satellite communication, but remotely operating a watercraft is enabled only within a coverage area of radio waves transmitted from a ground base station.

### SUMMARY OF THE INVENTION

Example embodiments of the present invention provide systems and methods by which a communication method for a watercraft is switchable from one to another depending on the situation.

According to an example embodiment of the present invention, a system for remotely operating a watercraft includes a controller, a communication interface, and a communication switch. The controller is disposed on the watercraft and is configured or programmed to control the watercraft. The communication interface is disposed on the watercraft and is configured to perform satellite communication using a satellite and terrestrial communication using a ground base station. The communication switch is configured to switch a communication method of the communication interface between the satellite communication and the terrestrial communication. The communication switch is configured to switch the communication method of the communication interface from the terrestrial communication to the satellite communication when radio waves transmitted from the ground base station are not receivable by the communication interface.

In the system for remotely operating a watercraft according to an example embodiment of the present invention, when the radio waves transmitted from the ground base station are not receivable by the communication interface, the communication method of the communication interface is switched from the terrestrial communication to the satellite communication. Accordingly, it is possible to remotely operate the watercraft by using the satellite communication even in a location outside the coverage area of the radio waves transmitted from the ground base station. On the contrary, when the radio waves transmitted from the ground base station are receivable by the communication interface, it is possible to remotely operate the watercraft by using the terrestrial communication. Consequently, it is possible to remotely operate the watercraft with accuracy by a communication method with less delay, for instance, during docking at a shore or in proximity to the shore.

A method of remotely operating a watercraft according to an example embodiment of the present invention is executed by a computer, the watercraft including a communication interface configured to perform satellite communication using a satellite and terrestrial communication using a ground base station. The method of remotely operating the watercraft includes switching the communication method of the communication interface from the terrestrial communication to the satellite communication when radio waves transmitted from the ground base station are not receivable by the communication interface.

According to example embodiments of the present invention, it is possible to provide systems and methods by which communication methods for watercraft are switchable between satellite communication and terrestrial communication depending on the situation.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a functional block diagram of a watercraft operating system according to an example embodiment of the present invention.

FIG. 2 is a diagram schematically showing navigation routes for a watercraft.

FIG. 3 is a flowchart showing a series of processes to be executed by a watercraft operating controller.

FIG. 4 is a flowchart showing a series of processes to be executed by the watercraft operating controller.

### DETAILED DESCRIPTION OF THE EXAMPLE EMBODIMENTS

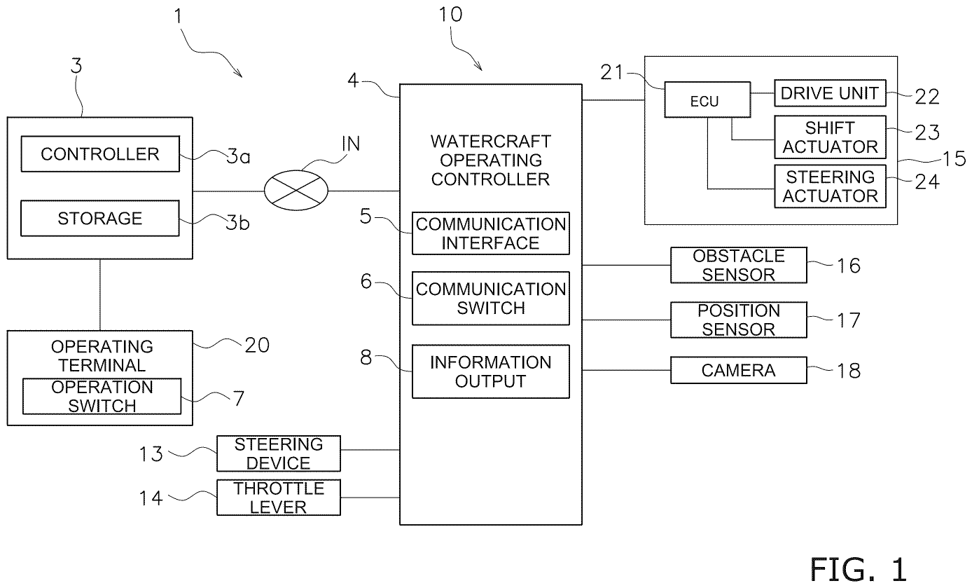

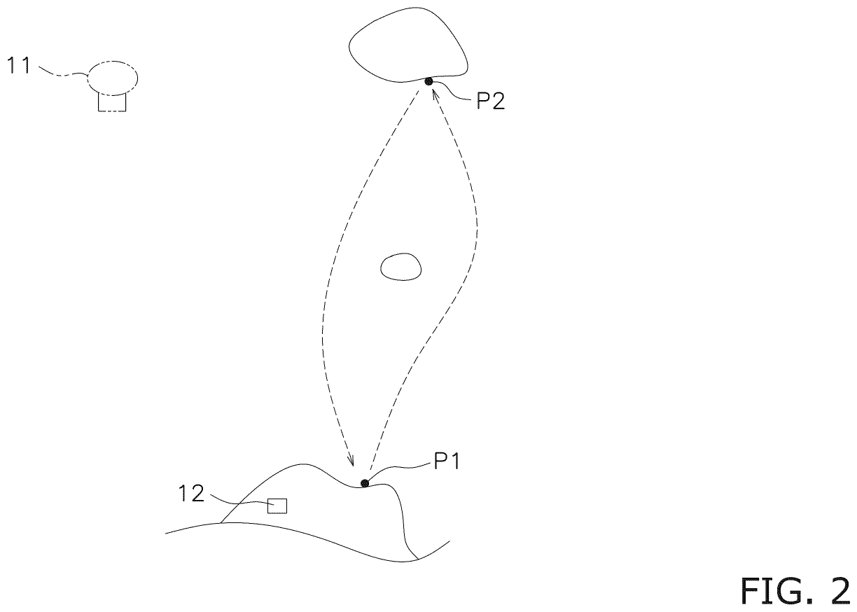

Example embodiments of the present invention will be hereinafter explained with reference to drawings. FIG. 1 is a functional block diagram of a system 1 for remotely operating a watercraft 10 (hereinafter referred to as a watercraft operating system). FIG. 2 is a diagram schematically showing navigation routes for the watercraft 10. As shown in FIG. 2, the watercraft operating system 1 is used as an application for remotely operating the watercraft 10 during round-trip navigation between a first port P1 and a second port P2 remote from the first port P1. In the watercraft operating system 1 according to the present example embodiment, the round-trip navigation between the first and second ports P1 and P2 is enabled for the watercraft 10 by automatically operating the watercraft 10. In other words, watercraft operating modes for the watercraft 10 in the present example embodiment include a remote watercraft operating mode for remotely operating the watercraft 10 and an automated watercraft operating mode for automatically operating the watercraft 10. It should be noted that in the watercraft operating system 1, the watercraft 10 does not have to be able to navigate the round trip between the first and second ports P1 and P2 by automatically operating the watercraft.

The watercraft 10 is an unmanned watercraft, for instance, and is used as an application to transport only supplies such as food and fuel. The distance from the first port P1 to the second port P2 is, for instance, 50 km. The second port P2 is located at, for instance, a remote island.

The watercraft operating system 1 includes a server 3, a watercraft operating controller 4 (exemplary controller), a communication interface 5, a communication switch 6, an operation switch 7, and an information output 8. The server 3 is used as, for instance, a computer to manage the watercraft 10. The server 3 is connected to an operating terminal 20 that monitors and remotely operates the watercraft 10 in a communicable manner. The server 3 and the operating terminal 20 are connected to be communicable with each other through a network such as the Internet. The server 3 is disposed on the ground. It should be noted that the server 3 may be disposed on the watercraft 10. The operating terminal 20 may be a communication terminal such as a smartphone or tablet.

The server 3 includes a controller 3a and a storage 3b. The controller 3a includes a processor such as a CPU (Central Processing Unit) and memories such as a RAM (Random Access Memory) and a ROM (Read Only Memory). The controller 3a controls the watercraft operating controller 4 in accordance with operation on the operating terminal 20. In the remote watercraft operating mode, the controller 3a is configured or programmed to remotely operate the watercraft 10 through the watercraft operating controller 4. The controller 3a is configured or programmed to switch the modes of operating the watercraft 10 from one to another based on an operation of the operating terminal 20. For example, in a condition that the watercraft 10 is being controlled by the automated watercraft operating mode, if the controller 3a receives, from the operating terminal 20, a signal to switch the modes of operating the watercraft 10 from the automated watercraft operating mode to the remote watercraft operating mode, the controller 3a switches the mode of operating the watercraft 10 from the automated watercraft operating mode to the remote watercraft operating mode.

The controller 3a is configured or programmed to be communicable with the watercraft operating controller 4 through the communication interface 5 by methods including satellite communication and terrestrial communication. The satellite communication is a communication method using a satellite 11. The terrestrial communication is a communication method using a ground base station 12 on the ground. The ground base station 12 may be, for instance, a wireless base station used for LTE (Long Term Evolution). The controller 3a is configured or programmed to switch the communication method to be performed by the communication interface 5 from one to another based on an operation of the operating terminal 20.

The storage 3b stores a variety of information and a variety of programs. The storage 3b includes, for instance, recording media/medium such as an HDD (Hard Disk Drive) and/or an SSD (Solid State Drive). The storage 3b stores information regarding the positions of the first and second ports P1 and P2, information regarding a nautical chart in the surroundings of the first and second ports P1 and P2, a coverage area of radio waves from the ground base station 12, and so forth. The storage 3b stores at least one route from the first port P1 to the second port P2 and at least one route from the second port P2 to the first port P1. It should be noted that the route from the first port P1 to the second port P2 and that from the second port P2 to the first port P1 may be identical to each other. The storage 3b may be included in the controller 3a or the watercraft operating controller 4.

As shown in FIG. 1, the watercraft 10 includes a steering device 13, a throttle lever 14, a marine propulsion device 15, an obstacle sensor 16, a position sensor 17, and a camera 18. The watercraft 10 additionally includes a variety of devices required to remotely operate the watercraft 10 (not shown in the drawings) such as a velocity sensor, an acceleration sensor, a compass sensor, and a sonar.

The steering device 13 changes the direction of the watercraft 10. The throttle lever 14 regulates the magnitude of a thrust generated by the marine propulsion device 15 and switches the orientations of the thrust between fore and aft directions.

The marine propulsion device 15 includes an ECU (Electronic Control Unit) 21, a drive unit 22, a shift actuator 23, and a steering actuator 24.

The ECU 21 includes a processor such as a CPU and memories such as a RAM and a ROM. The ECU 21 stores programs and data to control the marine propulsion device 15. The ECU 21 controls the drive unit 22. The drive unit 22 generates a propulsion force (thrust) to propel the watercraft 10. The drive unit 22 includes an internal combustion engine. The drive unit 22 may include an electric motor.

The shift actuator 23 changes the rotational directions of a propeller from one to another based on an operation of the throttle lever 14. The steering actuator 24 changes the rudder angle of the marine propulsion device 15 based on an operation of the steering device 13.

The obstacle sensor 16 detects an obstacle in the surroundings of the watercraft 10 and outputs information regarding the obstacle to the watercraft operating controller 4. The obstacle sensor 16 may be, for instance, a LiDAR (Light Detection and Ranging), a RADAR (Radio Detecting and Ranging), a millimeter wave radar, or so forth.

The position sensor 17 may be, for instance, a GPS (Global Positioning System) receiver. The position sensor 17 obtains information regarding the position of the watercraft 10 from a GPS satellite. The position sensor 17 is connected to the watercraft operating controller 4 in a communicable manner. The watercraft operating controller 4 obtains the position of the watercraft 10 from a signal outputted thereto from the position sensor 17.

The camera 18 is configured to capture moving images and still images. The camera 18 captures images of the surroundings of the watercraft 10 and generates image data. The camera 18 captures images of the fore, aft, port, and starboard sides from the watercraft 10. The camera 18 outputs the image data to the watercraft operating controller 4.

The watercraft operating controller 4 is disposed on the watercraft 10. The watercraft operating controller 4 is configured or programmed to control the watercraft 10. The watercraft operating controller 4 includes a processor such as a CPU and memories such as a RAM and a ROM. The watercraft operating controller 4 may store programs and data to control the marine propulsion device 15. The watercraft operating controller 4 is connected to the steering device 13, the throttle lever 14, and the marine propulsion device 15 by wired or wireless communication. The watercraft operating controller 4 controls the shift actuator 23 and the steering actuator 24 through the ECU 21.

The watercraft operating controller 4 is configured or programmed to enable the watercraft 10 to navigate to a destination by automatically controlling the watercraft 10. The destination herein refers to the first port P1 or the second port P2. In the automated watercraft operating mode, the watercraft operating controller 4 causes the watercraft 10 to automatically move from the first port P1 to the second port P2 or vice versa. For example, the watercraft operating controller 4 obtains watercraft operating information required to automatically operate the watercraft 10 based on an operation of the operating terminal 20 and causes the watercraft 10 to navigate to the destination by automatically operating the watercraft 10. The watercraft operating information includes, for instance, information regarding the navigation route, a nautical chart, weather, and the destination. The watercraft operating controller 4 transmits the following to the server 3: information obtained by a variety of sensors disposed on the watercraft 10 and the image data generated by the camera 18. The watercraft operating controller 4 is configured or programmed to cause the server 3 to display the information, obtained by the server 3 from the watercraft operating controller 4, on, for instance, a display of the operating terminal 20.

The communication interface 5 is disposed on the watercraft 10. The communication interface 5 is configured to perform the satellite communication and the terrestrial communication. The communication interface 5 is configured to perform one selected from the satellite communication and the terrestrial communication. The communication interface 5 causes the watercraft operating controller 4 to be connected therethrough to a network IN such as the Internet in a communicable manner. The communication interface 5 measures the intensity of the radio waves transmitted from the ground base station 12 and outputs the measured intensity to the watercraft operating controller 4.

The communication switch 6 switches the communication method to be performed by the communication interface 5 from one to another. The communication switch 6 is controlled by the watercraft operating controller 4. The communication switch 6 switches the communication method to be performed by the communication interface 5 from one to another based on a switching signal outputted thereto from the watercraft operating controller 4. For example, when the watercraft operating controller 4 determines that the radio waves transmitted from the ground base station 12 have become not receivable, the communication switch 6 switches the communication method to be performed by the communication interface 5 from the terrestrial communication to the satellite communication in response to the switching signal outputted thereto from the watercraft operating controller 4. On the contrary, when the watercraft operating controller 4 determines that the radio waves transmitted from the ground base station 12 have become receivable, the communication switch 6 switches the communication method to be performed by the communication interface 5 from the satellite communication to the terrestrial communication in response to the switching signal outputted thereto from the watercraft operating controller 4.

The watercraft operating controller 4 controls the communication switch 6 such that the terrestrial communication is performed by the communication interface 5 in priority to the satellite communication. Because of this, when the radio waves transmitted from the ground base station 12 are receivable by the communication interface 5, the terrestrial communication is prioritized in the communication method to be performed by the communication interface 5. It should be noted that when the radio waves transmitted from the ground base station 12 are receivable by the communication interface 5, and simultaneously, when the watercraft 10 has approached a position to which the watercraft 10 is docked, the watercraft operating controller 4 may control the communication switch 6 to switch the communication method to be performed by the communication interface 5 from the satellite communication to the terrestrial communication. Alternatively, when the satellite communication is used in the open ocean, and simultaneously, when the watercraft 10 has approached the docking position, the watercraft operating controller 4 may control the communication switch 6 to switch the communication method to be performed by the communication interface 5 from the satellite communication to the terrestrial communication.

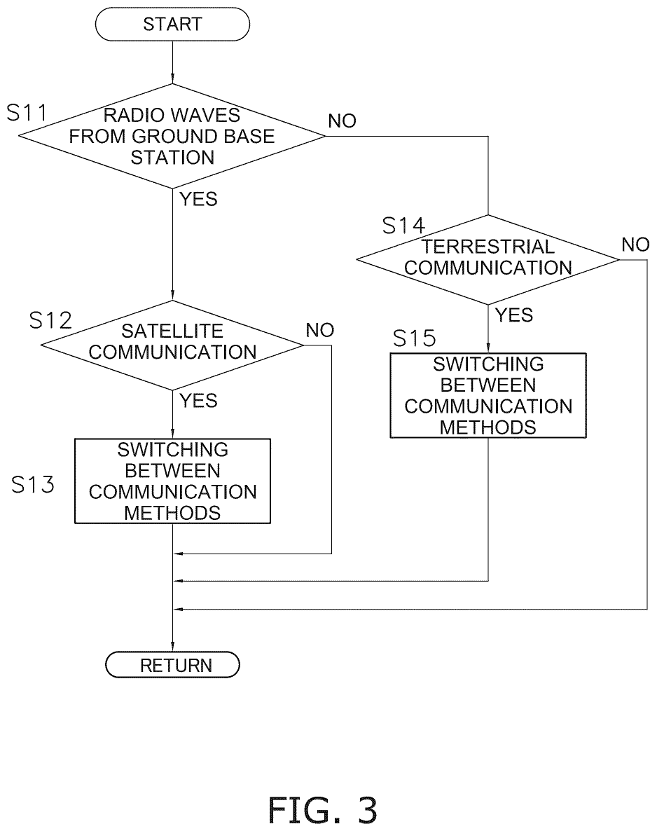

FIG. 3 is a flowchart showing a series of processes to be executed by the watercraft operating controller 4. In step S11, the watercraft operating controller 4 determines whether or not the radio waves transmitted from the ground base station 12 are receivable based on, for instance, the information regarding the measurement result of the radio wave intensity by the communication interface 5. It should be noted that in step S11, the watercraft operating controller 4 may determine whether or not the communication interface 5 is communicable with the controller 3a by the terrestrial communication.

When the watercraft operating controller 4 determines that the radio waves transmitted from the ground base station 12 are receivable, the process proceeds to step S12. Then, the watercraft operating controller 4 determines whether or not the satellite communication has been selected from the communication method to be performed by the communication interface 5. When it is determined that the satellite communication has been selected as the communication method to be performed by the communication interface 5, the watercraft operating controller 4 causes the communication switch 6 to switch the communication method to be performed by the communication interface 5 from the satellite communication to the terrestrial communication (step S13). It should be noted that in step S12, when the watercraft operating controller 4 determines that the satellite communication has not been selected as the communication method to be performed by the communication interface 5, the present communication method of the terrestrial communication is maintained.

When the watercraft operating controller 4 determines that radio waves transmitted from the ground base station 12 are not receivable, the process proceeds to step S14. Then, the watercraft operating controller 4 determines whether or not the terrestrial communication has been selected as the communication method to be performed by the communication interface 5. When it is determined that the terrestrial communication has been selected as the communication method to be performed by the communication interface 5, the watercraft operating controller 4 causes the communication switch 6 to switch the communication method to be performed by the communication interface 5 from the terrestrial communication to the satellite communication (step S15).

It should be noted that, when it is determined that the satellite communication has been selected as the communication method to be performed by the communication interface 5 in step S12, the watercraft operating controller 4 may determine whether or not the watercraft 10 has approached the docking position. Then, when the watercraft operating controller 4 determines that the watercraft 10 has approached the docking position, the process may proceed to step S13. The watercraft operating controller 4 may determine whether or not the watercraft 10 has approached the docking position by, for instance, by calculating the distance from the docking position to the watercraft 10.

The operation switch 7 switches the communication method to be performed by the communication interface 5 from one to another. The operation switch 7 is disposed in, for instance, the operating terminal 20. When the watercraft 10 is controlled in the remote watercraft operating mode, the communication switch 6 switches the communication method to be performed by the communication interface 5 from one to another based on an operation of the operation switch 7. Accordingly, a user, who is remotely operating the watercraft 10, is allowed to manually switch the communication method to be performed by the communication interface 5 from one to another.

When the communication method of the communication interface 5 is the satellite communication, the information output 8 outputs information regarding a delay due to the satellite communication. The watercraft operating controller 4 limits the velocity of the watercraft 10 in accordance with the information outputted thereto from the information output 8. The information output 8 measures, for instance, the duration of the delay in communication between the controller 3a and the watercraft operating controller 4 due to the satellite communication. When the duration of the delay in communication due to the satellite communication is greater than a predetermined value, the watercraft operating controller 4 limits the velocity of the watercraft 10, for instance, with reference to a velocity limit map that defines a relationship between duration of the delay in communication and the velocity limit.

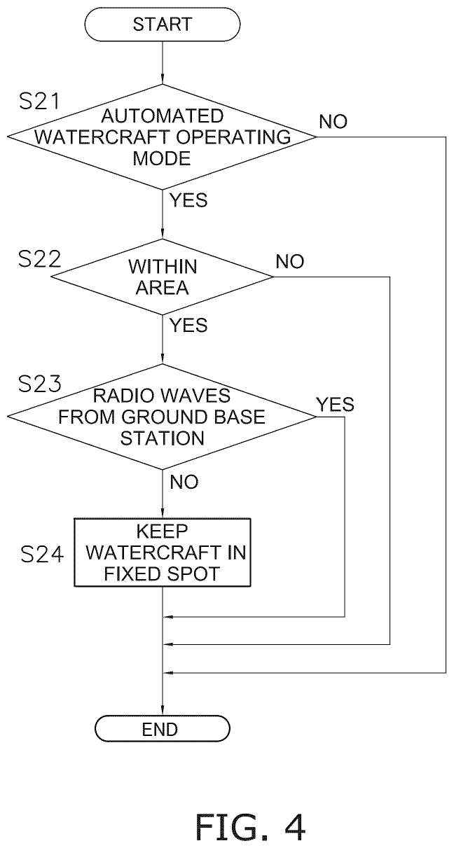

FIG. 4 is a flowchart showing a series of processes to be executed by the watercraft operating controller 4. The watercraft operating controller 4 controls the watercraft 10 to be kept in a fixed spot when radio waves transmitted from the ground base station 12 are not receivable within a coverage area of the radio waves during execution of the automated watercraft operating mode. Keeping the watercraft 10 in the fixed spot includes keeping the watercraft 10 within a predetermined range.

When the watercraft operating controller 4 determines that the automated watercraft operating mode has been executed in step S21, the process proceeds to step S22. When the watercraft operating controller 4 determines that the watercraft 10 is located at present in the coverage area of the radio waves transmitted from the ground base station 12 in step S22, the process proceeds to step S23. When the watercraft operating controller 4 determines that the radio waves transmitted from the ground base station 12 are not receivable in step S23, the process proceeds to step S24. Then, the watercraft operating controller 4 keeps the watercraft 10 in the fixed spot until the radio waves transmitted from the ground base station 12 become receivable. When the radio waves transmitted from the ground base station 12 have become receivable, the watercraft operating controller 4 causes the communication switch 6 to switch the communication method to be performed by the communication interface 5 from the satellite communication to the terrestrial communication and thereafter releases the watercraft 10 from being kept in the fixed spot. It should be noted that in step S24, the watercraft operating controller 4 may limit the velocity of the watercraft 10 instead of keeping the watercraft 10 in the fixed spot.

When it is determined that a predetermined condition (or conditions) is satisfied during execution of the automated watercraft operating mode, the watercraft operating controller 4 outputs an abnormal signal. The watercraft operating controller 4 determines whether or not the predetermined condition has been satisfied based on the image data generated by the camera 18. When it is determined that the image data cannot be correctly recognized, for instance, the watercraft operating controller 4 causes the server 3 to output the abnormal signal to, for instance, the operating terminal 20. The watercraft operating controller 4 may determine that the predetermined condition has been satisfied when any of the following conditions, for instance, has occurred: attachment of water droplets to the camera 18, the orientation of the camera 18 is facing toward the sunlight, and displacement in the position of the camera 18. Alternatively, the watercraft operating controller 4 may determine that the predetermined condition has been satisfied when any of the following conditions, for instance, has occurred: difficulty in avoiding an obstacle by continuing the automated navigation as it is, inability of continuing the automated watercraft operation, and inability of receiving the radio waves transmitted from the ground base station 12 in proximity to the docking position.

In the watercraft operating system 1 described above, when the radio waves transmitted from the ground base station 12 are not receivable, the communication method to be performed by the communication interface 5 is switched from the terrestrial communication to the satellite communication. Accordingly, even in a location outside the coverage area of the radio waves transmitted from the ground base station 12, it is possible to remotely operate the watercraft 10 by using the satellite communication. On the contrary, when the radio waves transmitted from the ground base station 12 are receivable, it is possible to remotely operate the watercraft 10 by using the terrestrial communication. Consequently, it is possible to remotely operate the watercraft 10 with accuracy by a communication method with less delay during docking at a shore or in proximity to the shore.

Example embodiments of the present invention have been explained above. However, the present invention is not limited to the example embodiments described above and a variety of changes can be made without departing from the gist of the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A system for remotely operating a watercraft, the system comprising:
a controller disposed on the watercraft and configured or programmed to control the watercraft;
a communication interface disposed on the watercraft and configured to perform satellite communication using a satellite and terrestrial communication using a ground base station; and
a communication switch to switch a communication method of the communication interface between the satellite communication and the terrestrial communication; wherein
the communication switch is configured to switch the communication method of the communication interface from the terrestrial communication to the satellite communication when radio waves transmitted from the ground base station are not receivable by the communication interface.

2. The system according to claim 1, wherein the communication switch is configured to switch the communication method of the communication interface from the satellite communication to the terrestrial communication when the radio waves transmitted from the ground base station are receivable by the communication interface.

3. The system according to claim 1, wherein the communication switch is configured to switch the communication method of the communication interface from the satellite communication to the terrestrial communication when the radio waves transmitted from the ground base station are receivable by the communication interface and the watercraft has approached a position to which the watercraft is docked.

4. The system according to claim 1, wherein the controller is configured or programmed to prioritize the terrestrial communication when the radio waves transmitted from the ground base station are receivable.

5. The system according to claim 1, further comprising:
an information output to output information regarding a delay in the satellite communication when the communication method of the communication interface is the satellite communication.

6. The system according to claim 5, wherein the controller is configured or programmed to limit a velocity of the watercraft based on the information outputted from the information output.

7. The system according to claim 1, further comprising:
an operation switch to switch the communication method of the communication interface between the satellite communication and the terrestrial communication; wherein
the communication switch is configured to switch the communication method of the communication interface between the satellite communication and the terrestrial communication based on an operation of the operation switch.

8. The system according to claim 1, wherein
the controller is configured or programmed to enable the watercraft to navigate to a destination by automatically operating the watercraft; and
the controller is configured or programmed to either (a) keep the watercraft in a fixed spot or (b) limit a velocity of the watercraft when the radio waves transmitted from the ground base station are not receivable within a coverage area of the radio waves transmitted from the ground base station.

9. The system according to claim 1, wherein the controller is configured or programmed to enable the watercraft to navigate to a destination by automatically operating the watercraft, and to output an abnormal signal when it is determined that a predetermined condition has been satisfied during the automatically operating the watercraft.

10. The system according to claim 9, further comprising:
a camera to capture images of surroundings of the watercraft and to generate image data; wherein
the controller is configured or programmed to determine whether or not the predetermined condition has been satisfied based on the image data.

11. A method of remotely operating a watercraft, the watercraft including a communication interface configured to perform satellite communication using a satellite and terrestrial communication using a ground base station, the method being executed by a computer and comprising:
switching a communication method of the communication interface from the terrestrial communication to the satellite communication when radio waves transmitted from the ground base station are not receivable by the communication interface.

12. The method according to claim 11, further comprising:
switching the communication method of the communication interface from the satellite communication to the terrestrial communication when the radio waves transmitted from the ground base station are receivable by the communication interface.

13. The method according to claim 11, further comprising:
switching the communication method of the communication interface from the satellite communication to the terrestrial communication when the radio waves transmitted from the ground base station are receivable by the communication interface and the watercraft has approached a position to which the watercraft is docked.

14. The method according to claim 11, further comprising:
prioritizing the terrestrial communication over the satellite communication when the radio waves transmitted from the ground base station are receivable by the communication interface.

15. The method according to claim 11, further comprising:
outputting information regarding a delay in the satellite communication when the communication method of the communication interface is the satellite communication.

16. The method according to claim 15, further comprising:
limiting a velocity of the watercraft based on the outputted information regarding the delay in the satellite communication.

17. The method according to claim 11, wherein the watercraft further includes an operation switch to switch the communication method of the communication interface between the satellite communication and the terrestrial communication, the method further comprising:
switching the communication method of the communication interface based on an operation of the operation switch.

18. The method according to claim 11, wherein the watercraft is able to automatically navigate to a destination, the method further comprising:
either (a) keeping the watercraft in a fixed spot or (b) limiting a velocity of the watercraft when the radio waves transmitted from the ground base station are not receivable by the communication interface within a coverage area of the radio waves transmitted from the ground base station.

19. The method according to claim 11, further comprising:
automatically operating the watercraft to enable the watercraft to navigate to a destination; and
outputting an abnormal signal when it is determined that a predetermined condition has been satisfied during the automatically operating the watercraft.

20. The method according to claim 19, further comprising:
capturing images of surroundings of the watercraft to generate image data; and
determining whether or not the predetermined condition has been satisfied based on the image data.
